(19) United States
(12) Patent Application Publication
(10) Pub. No.: US 2025/0014031 A1
(43) Pub. Date: Jan. 9, 2025

(54) METHOD AND SYSTEM FOR DETECTING FRAUDULENT TRANSACTIONS INVOLVING NON-FUNGIBLE TOKENS (NFT)

(71) Applicant: Mastercard International Incorporated, Purchase, NY (US)

(72) Inventors: Garima ARORA, Delhi (IN); Adarsh PATANKAR, Betul (IN)

(21) Appl. No.: 18/218,254

(22) Filed: Jul. 5, 2023

(51) Int. Cl. G06Q 20/40; G06Q 20/36; G06Q 20/38

(52) U.S. Cl. CPC G06Q 20/401; G06Q 20/36; G06Q 20/389

(57) ABSTRACT

A method for scoring authenticity of a non-fungible token (NFT) using multiple, disparate data sets includes: receiving a scoring request for the NFT; determining a marketplace authenticity score for a marketplace where the NFT is available for purchase based on marketplace metrics; determining a visual authenticity score based on a comparison of visual features of the NFT to visual features of trusted NFTs; determining a wallet authenticity score for a blockchain wallet associated with ownership of the NFT based on a transaction history for the blockchain wallet; calculating a confidence score for the NFT based on a combination of the marketplace, visual, and wallet authenticity scores, the confidence score representing a likelihood that the NFT is authentic; and transmitting the calculated confidence score in response to the received scoring request.

### FIELD

The present disclosure relates to the detection of potential fraud in cryptocurrency transactions, specifically the scoring of authenticity for non-fungible tokens (NFTs) using marketplace, visual, and transactional data.

### BACKGROUND

Blockchains were first created as a way of providing for a cryptographic currency that could be transferred among participants in a decentralized manner that provided the participants with anonymity. Over time, participants discovered new uses for blockchains in a variety of different industries and applications. A recent new application for blockchains is in conjunction with non-fungible tokens, most commonly referred to as “NFTs.” An NFT is a unique digital object that can be bought and sold, whose provenance is tracked on a blockchain. At its inception, NFTs were most often digital artwork, but they have since expanded to also include other digital objects, such as representing items in online video games, songs, sports video clips, etc. An NFT, once created, is stored in a blockchain with transfers of ownership recorded therein.

Much of the value of an NFT comes from its uniqueness; the purchaser can claim ownership of the NFT and show it off to others the same way an art collector can. Still, like with traditional, physical paintings, there is little to stop someone from creating a copy of the digital object. In most cases, the copy is marketed as such and has a significantly lower value than the original. However, nefarious actors can make a copy of an existing NFT, and present is as the original (e.g., representing that they have the real Mona Lisa), can make an NFT and claim to be a famous artist (e.g., Banksy), or can make an NFT that they claim comes from a famous artist (e.g., representing a painting having been done by Picasso). Currently, there are no systems designed for authenticating an NFT or the seller thereof. While a more tech savvy purchaser can identify the history of an NFT on a blockchain, they can still be unable to determine if the NFT itself or the seller are genuine.

Thus, there is a need for a technical system that can provide a measure of authenticity for an NFT, regarding authenticity of the NFT itself as well as the marketplace on which the NFT is sold and the seller of the NFT, for users prior to purchase.

### SUMMARY

The present disclosure provides a description of systems and methods for scoring the authenticity of a non-fungible token (NFT) using multiple, disparate data sets. A requestor can request the scoring of an NFT by a processing server. The processing server can gather data from multiple sources to determine authenticity scores for various aspects of the NFT and its sale. The processing server can determine a first score (herein referred to as a marketplace authenticity score) for the marketplace, such as a webpage or application program, where the NFT is sold, which can be based on marketplace metrics, such as network traffic, social media traffic, domain registration data, and popularity, and also on a comparison of the visuals of the marketplace, to represent how likely that the marketplace is genuine and not, for example, a phishing website. The processing server can also determine a second score (herein referred to as a visual authenticity score) for the NFT itself, by comparing one or more visual features of the NFT to existing NFTs, and in particular existing trusted NFTs, to determine if the NFT being sold is a copy of an already existing NFT. The processing server can also determine a third score (herein referred to as a wallet authenticity score) for the blockchain wallet that is selling the NFT based on at least its transaction history, which can represent a likelihood that the blockchain wallet is genuine and was the actual creator of the NFT or an authorized owner, and a likelihood that the blockchain wallet has not participated in past fraudulent transfers. The processing server can also determine a fourth score, which can be an additional risk score based on gathered marketplace and/or transactional data, such as if the marketplace supports buying and/or selling NFTs via the use of payment cards. The processing server can calculate a confidence score for the sale of the NFT using all of the authenticity scores, and provide the confidence score back to the requestor, who can then decide whether or not to purchase the NFT using the confidence score for guidance. The result makes for a significantly more well-informed purchaser regardless of technological savvy based on a variety of different data that can be prohibitively difficult for a nefarious actor to deceive.

A method for scoring authenticity of a non-fungible token (NFT) using multiple, disparate data sets includes: receiving, by a receiver of a processing server, a scoring request for the NFT including at least one of the NFT or an identification value associated with the NFT; determining, by a processor of the processing server, a marketplace authenticity score for a marketplace where the NFT is available for purchase based on at least one or more marketplace metrics; determining, by the processor of the processing server, a visual authenticity score based on at least a comparison of one or more visual features of the NFT to visual features of a plurality of trusted NFTs; determining, by the processor of the processing server, a wallet authenticity score for a blockchain wallet associated with ownership of the NFT based on at least a transaction history for the blockchain wallet; calculating, by the processor of the processing server, a confidence score for the NFT based on a combination of at least the determined marketplace authenticity score, the visual authenticity score, and the wallet authenticity score, the confidence score representing a likelihood that the NFT is authentic; and transmitting, by a transmitter of the processing server, the calculated confidence score in response to the received scoring request.

A system for scoring authenticity of a non-fungible token (NFT) using multiple, disparate data sets includes: a blockchain wallet associated with ownership of the NFT; a marketplace; and a processing server, the processing server including a receiver receiving a scoring request for the NFT including at least one of the NFT or an identification value associated with the NFT; a processor determining (i) a marketplace authenticity score for the marketplace where the NFT is available for purchase based on at least one or more marketplace metrics, (ii) a visual authenticity score based on at least a comparison of one or more visual features of the NFT to visual features of a plurality of trusted NFTs, and (iii) a wallet authenticity score for the blockchain wallet based on at least a transaction history for the blockchain wallet, and calculating a confidence score for the NFT based on a combination of at least the determined marketplace authenticity score, the visual authenticity score, and the wallet authenticity score, the confidence score representing a likelihood that the NFT is authentic; and a transmitter transmitting the calculated confidence score in response to the received scoring request.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high-level system architecture for scoring authenticity of an NFT using multiple data sets in accordance with exemplary embodiments.

FIG. 2 is a block diagram illustrating the processing server in the system of FIG. 1 for scoring authenticity of an NFT using multiple data sets in accordance with exemplary embodiments.

FIG. 3 is a flow diagram illustrating a process for scoring authenticity of an NFT using multiple data sets in the system of FIG. 1 in accordance with exemplary embodiments.

FIG. 4 is a flow chart illustrating an exemplary method for scoring authenticity of an NFT using multiple data sets in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### System for Authenticity Scoring of Non-Fungible Tokens

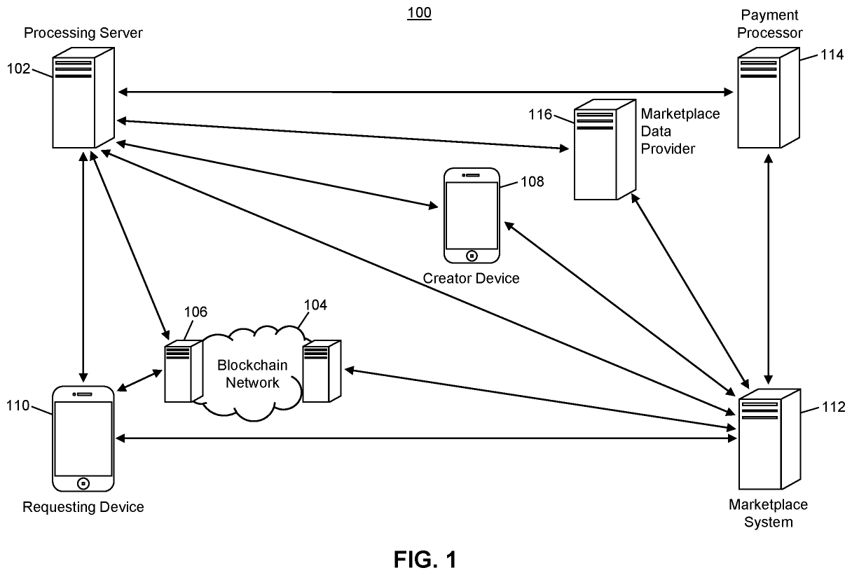

FIG. 1 illustrates a system 100 for the scoring of authenticity of non-fungible tokens (NFTs) using multiple, disparate data sets and authenticity of various aspects of an NFT and the transfer thereof. The system 100 can include a processing server 102. The processing server 102, discussed in more detail below, can be configured to determine authentication scores for aspects of the transfer of an NFT, including marketplace, visual, wallet authenticity, etc., and determine a confidence score for an NFT based on multiple data sets.

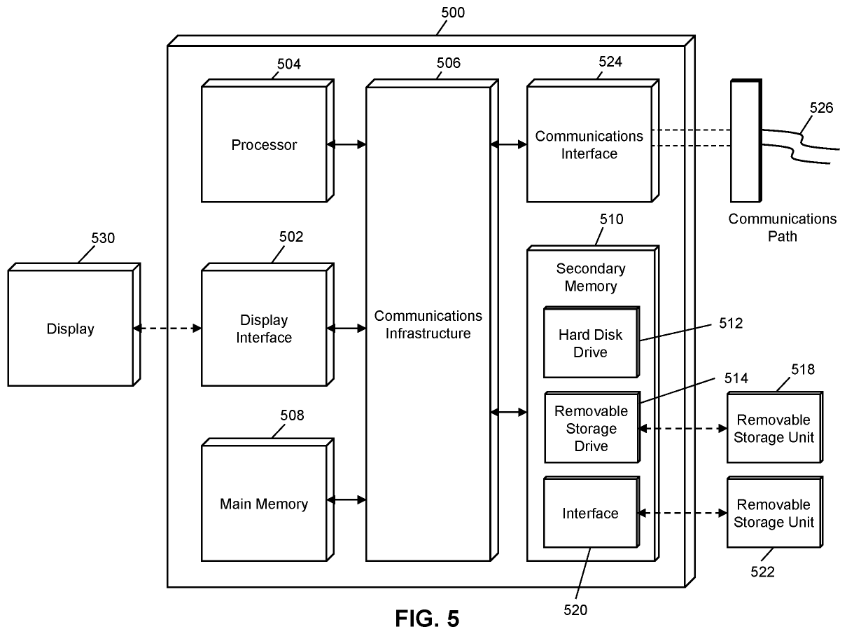

The system 100 can include a blockchain network 104. The blockchain network 104 can be comprised of a plurality of blockchain nodes 106. Each blockchain node 106 can be a computing system, such as illustrated in FIG. 5, discussed in more detail below, that is configured to perform functions related to the processing and management of the blockchain, including the generation of blockchain data values, verification of proposed blockchain transactions, verification of digital signatures, generation of new blocks, validation of new blocks, and maintenance of a copy of the blockchain.

The blockchain can be a distributed ledger that is comprised of at least a plurality of blocks. Each block can include at least a block header and one or more data values. Each block header can include at least a timestamp, a block reference value, and a data reference value. The timestamp can be a time at which the block header was generated and can be represented using any suitable method (e.g., UNIX timestamp, DateTime, etc.). The block reference value can be a value that references an earlier block (e.g., based on timestamp) in the blockchain. In some embodiments, a block reference value in a block header can be a reference to the block header of the most recently added block prior to the respective block. In an exemplary embodiment, the block reference value can be a hash value generated via the hashing of the block header of the most recently added block. The data reference value can similarly be a reference to the one or more data values stored in the block that includes the block header. In an exemplary embodiment, the data reference value can be a hash value generated via the hashing of the one or more data values. For instance, the block reference value can be the root of a Merkle tree generated using the one or more data values.

The use of the block reference value and data reference value in each block header can result in the blockchain being immutable. Any attempted modification to a data value would require the generation of a new data reference value for that block, which would thereby require the subsequent block's block reference value to be newly generated, further requiring the generation of a new block reference value in every subsequent block. This would have to be performed and updated in every single blockchain node 106 in the blockchain network 104 prior to the generation and addition of a new block to the blockchain in order for the change to be made permanent. Computational and communication limitations can make such a modification exceedingly difficult, if not impossible, thus rendering the blockchain immutable.

In some embodiments, the blockchain can be used to store information regarding blockchain transactions conducted between two different blockchain wallets. A blockchain wallet can include a private key of a cryptographic key pair that is used to generate digital signatures that serve as authorization by a payer for a blockchain transaction, where the digital signature can be verified by the blockchain network 104 using the public key of the cryptographic key pair. In some cases, the term “blockchain wallet” can refer specifically to the private key. In other cases, the term “blockchain wallet” can refer to a computing device (e.g., requesting device 110, creator device 108, etc.) that stores the private key for use thereof in blockchain transactions. For instance, each computing device can each have their own private key for respective cryptographic key pairs and can each be a blockchain wallet for use in transactions with the blockchain associated with the blockchain network. Computing devices can be any type of device suitable to store and utilize a blockchain wallet, such as a desktop computer, laptop computer, notebook computer, tablet computer, cellular phone, smart phone, smart watch, smart television, wearable computing device, implantable computing device, etc.

Each blockchain data value stored in the blockchain can correspond to a blockchain transaction or other storage of data, as applicable. A blockchain transaction can consist of at least: a digital signature of the sender of currency (e.g., a requesting device 110) that is generated using the sender's private key, a blockchain address of the recipient of currency (e.g., a creator device 108) generated using the recipient's public key, and a blockchain currency amount that is transferred or other data being stored. In some blockchain transactions, the transaction can also include one or more blockchain addresses of the sender where blockchain currency is currently stored (e.g., where the digital signature proves their access to such currency), as well as an address generated using the sender's public key for any change that is to be retained by the sender. Addresses to which cryptographic currency has been sent that can be used in future transactions are referred to as “output” addresses, as each address was previously used to capture output of a prior blockchain transaction, also referred to as “unspent transactions,” due to there being currency sent to the address in a prior transaction where that currency is still unspent. In some cases, a blockchain transaction can also include the sender's public key, for use by an entity in validating the transaction. For the traditional processing of a blockchain transaction, such data can be provided to a blockchain node 106 in the blockchain network 104, either by the sender or the recipient. The node can verify the digital signature using the public key in the cryptographic key pair of the sender's wallet and also verify the sender's access to the funds (e.g., that the unspent transactions have not yet been spent and were sent to address associated with the sender's wallet), a process known as “confirmation” of a transaction, and then include the blockchain transaction in a new block. The new block can be validated by other blockchain nodes 106 in the blockchain network 104 before being added to the blockchain and distributed to all of the blockchain nodes 106 in the blockchain network 104, respectively, in traditional blockchain implementations. In cases where a blockchain data value cannot be related to a blockchain transaction, but instead the storage of other types of data, blockchain data values can still include or otherwise involve the validation of a digital signature.

In the system 100, the creator device 108 (e.g., or a user of the creator device 108, collectively referred to herein as the creator device 108) can create a new NFT. The NFT can be any digital object that can be stored on a blockchain directly or via a reference identifier associated with the digital object (e.g., a hash value generated using the digital object). The creator device 108 can submit the NFT to a marketplace system 112 to make available for sale. The marketplace system 112 can be a computing system configured to perform the functions discussed herein, which can include the receipt, storage, and posting of NFTs for sale and the tracking of ownership transfers thereof. In some cases, the marketplace system 112 can be a blockchain node 106 in a blockchain network 104 that stores data related to NFTs. In other cases, the marketplace system 112 can be in communication with one or more blockchain nodes 106 in a blockchain network 104 that operates a blockchain for the storage of NFT data.

The marketplace system 112 can receive the NFT along with information associated with the creator device 108. The information can include a public key of the blockchain wallet of the creator device 108 or other identifying information. In some cases, the NFT can be digitally signed by the creator device 108 using the private key of its blockchain wallet. The marketplace system 112 can (e.g., directly or via a blockchain node 106) store the NFT and creator information in a blockchain. The marketplace system 112 can then post the NFT as available for purchase. The marketplace system 112 can use any suitable type of interface for displaying NFTs available for purchase, such as via a web page, application program, application programming interface, etc. In some cases, the creator device 108 can specify a cost for the NFT, such as a specific type of currency and associated amount. In other cases, the NFT can be posted by the marketplace system 112 for sale in an auction where potential buyers can bid to purchase the NFT.

In some embodiments, the marketplace system 112 can offer the NFT for sale on behalf of an entity other than the creator of the NFT. For example, a purchaser can purchase the NFT from the creator device 108 and then offer the NFT for sale via the marketplace system 112. In another example, the creator device 108 can create the NFT and transfer ownership to a third party for sale. In some cases, the marketplace system 112 can obtain ownership of the NFT prior to its sale on the marketplace. As discussed herein, the creator device 108 can refer to the blockchain wallet or associated device that is offering the NFT for sale via the marketplace system 112.

In the system 100, a requesting device 110 (e.g., or a user thereof, collectively referred to herein as the requesting device 110) can be interested in purchasing the NFT from the creator device 108 using the marketplace system 112. The requesting device 110 can be interested in obtaining a confidence score for the NFT and its purchase to ensure that the NFT and creator device 108 are genuine. The requesting device 112 can collect data regarding the potential transaction and submit a scoring request to the processing server 102 using a suitable communication network and method. The scoring request can include at least the NFT or identification thereof (e.g., blockchain address on the blockchain, an identification value, etc.) as well as any other information regarding the NFT and its sale, such as a marketplace identifier identifying the marketplace system 112 where the NFT is being offered for sale, a wallet identifier for the blockchain wallet of the creator device 108, a recipient for payment to be made by the requesting device 110 for the purchase of the NFT, etc.

The processing server 102 can receive the scoring request from the requesting device 110 and identify any additional data regarding the NFT and its potential purchase not already included in the scoring request. For instance, if the scoring request does not identify the marketplace system 112 or the creator device 108, the processing server 102 can identify the marketplace system 112 using the NFT and/or its identifier and then, via the marketplace system 112, identify the creator device 108 that is offering the NFT for sale.

The processing server 102 can then determine a series of authenticity scores regarding the NFT and potential purchase thereof. The processing server 102 can determine a marketplace authenticity score that represents the authenticity of the marketplace system 112 where the NFT is being offered for sale. The processing server 102 can identify one or more marketplace metrics associated with the marketplace system 112, which can be used to determine the authenticity score. Marketplace metrics can be identified by the processing server 102 using available data or can be received by the processing server 102 from one or more sources, such as one or more marketplace data providers 116. Marketplace data providers 116 can be entities that are configured to gather and/or analyze data regarding marketplace systems 112, where such data can be made available to the processing server 102 for use in performing the functions discussed herein. Marketplace metrics can include, for example, popularity rankings, network traffic (e.g., number of unique visitors, visitor frequency, etc.), social media traffic (e.g., mentions, unique visitors to associated social media profiles, etc.), registration data (e.g., domain registration data for a webpage, application store registration data for an application program, etc.), etc. In an example, a webpage that has a very low page ranking as well as a very low (e.g., in comparison to other marketplaces) number of unique visitors can have a low authenticity score indicative of a low level of confidence in the genuineness of the marketplace system 112 and/or transaction for purchase of the NFT. The authenticity score can be determined using the available metrics and any suitable model, such as an Extreme Gradient Boosting model.

In some cases, the marketplace authenticity score can also be based on one or more visual features of the marketplace. For instance, the marketplace system 112 can utilize a webpage as the interface through which the requesting device 110 can purchase the NFT. The visual features of the marketplace can include images, layout, logos, fonts, etc. of the webpage, where the processing server 102 can compare these visual features with known visual features associated with the genuine entity represented by the marketplace system 112. For example, if the marketplace system 112 purports to be associated with a known entity, the colors and logos of the webpage can be compared with branding standards for the known entity to ensure that the webpage is genuine and not a phishing attempt or unauthorized duplication of a genuine marketplace associated with the known entity. In some embodiments, genuine marketplaces can be identified in a database of trusted marketplaces, which can be maintained by the processing server 102 or other entity. In some cases, the comparison can be made by the processing server 102 using one or more of a Siamese model, Deep Learning model, and Feature Maps.

In addition to the marketplace authenticity score, the processing server 102 can determine a visual authenticity score for the NFT. The visual authenticity score can represent a likelihood that the NFT is genuine and not an unauthorized duplicate of an existing NFT. The processing server 102 can compare one or more visual features of the NFT (e.g., color, resolution, formatting, etc.) with the visual features of existing NFTs, particularly trusted (e.g., determined to be genuine) NFTs. If the NFT identified in the scoring request is very similar to an existing, trusted NFT but with a slight color change, the determined authenticity score can be significantly low due to the likelihood that the NFT is an unauthorized duplication. In some cases, the comparison can be made by the processing server 102 using one or more of a Siamese model, Deep Learning model, and Feature Maps. In some instances, if the processing server 102 determines that the NFT identified in the scoring request is the same or similar to another NFT, the processing server 102 can identify the histories of the identified NFT and the another NFT to determine if the identified NFT was created prior to the another NFT (e.g., indicating that the another NFT can be a duplicate of the identified NFT), such as based on timestamps of blockchain data entries in the blockchain where each respective NFT was first registered on the blockchain. In some cases, such data can be used in the authenticity score. For example, if the identified NFT was registered on the blockchain prior to any NFT that is determined to have similarity, the authenticity score can be much higher than if the identified NFT was newly registered on the blockchain.

The processing server 102 can also determine a wallet authenticity score. The wallet authenticity score can be a score that represents a likelihood that the creator device 108 (e.g., or other blockchain wallet that is offering the NFT for sale) is genuine and not engaged in fraudulent activities. The processing server 102 can identify a transaction history for the blockchain wallet on the blockchain and determine the wallet authenticity score based on at least that transaction history, where a transaction history indicative of fraudulent activity can result in a lower wallet authenticity score. Factors that can be indicative of fraudulent activity can include a limited transaction history, an unusually high (e.g., compared to other creator devices 108) transaction history, a high frequency of transactions with a limited number of other blockchain wallets (e.g., indicative of one or more nefarious actors performing a large number of transfers to appear genuine), past transactions that have been found to involve fraud, etc. In some cases, the processing server 102 can utilize a database of suspicious blockchain wallets, which can be maintained by the processing server 102, a blockchain node 106, or a third-party entity, where the wallet authenticity score can also be based on whether or not the creator device 108 appears in the database of suspicious blockchain wallets.

In some embodiments, the processing server 102 can further determine one or more additional risk scores based on any additional data. In one example, the marketplace system 112 can support the purchase and/or transfer of NFTs via the use of electronic payment cards, such as credit cards, debit cards, etc. In such an example, transaction data and other data associated with such payment cards can be used in the generation of an additional risk score. For instance, if the NFT was previously purchased via a payment card with a lengthy history of genuine payment transactions, a very low associated risk score can be identified by the processing server 102, which can indicate that the proposed sale of the NFT is more likely to be genuine. In another example, if multiple NFTs are for sale that were purchased using the same payment card that has no other transaction history, a much greater associated risk score can be identified, indicating a higher likelihood at attempted fraud. Once the authenticity scores (i.e., the marketplace authenticity score, the visual authenticity score, and wallet authenticity score) have been determined, the processing server 102 can calculate a confidence score for the NFT. The confidence score can be based on a combination of each of the authenticity scores. In some cases, the confidence score can be an average of each of the authenticity scores. In some instances, the confidence score can be based on a weighted average of the authenticity scores, where the weighting can be static (e.g., a set weighting for each of the authenticity scores) or dynamic (e.g., the weight of an authenticity score is increased as the authenticity score is multiple standard deviations away from a median score). For example, in a dynamic weighting, a wallet authenticity score of 90 can have a higher weighting when calculating the confidence score than a wallet authenticity score of 60.

Once the confidence score is calculated, the processing server 102 can electronically transmit the confidence score to the requesting device 110 in response to the scoring request using a suitable communication network and method. In some cases, the processing server 102 can also provide the authenticity scores and, in some instances, the weighting of the authenticity scores, for use by the user of the requesting device 110. In some embodiments, the processing server 102 can also include any additional risk scores. The requesting device 110 can display the score(s) to the user, who can then decide whether or not to purchase the NFT.

In some embodiments, the processing server 102 can also determine a transaction authenticity score. The transaction authenticity score can represent a likelihood that the creator device 108 is genuine based on its past payment transactions. In such embodiments, the processing server 102 can identify the transaction account to be used by the creator device 108 to receive payment from the requesting device 110 if the NFT were to be purchased, which can be identified in the scoring request, from the marketplace system 112, from the creator device 108, or any other suitable entity. For example, the creator device 108 can have a merchant identification number used for receiving payments, a public key for a blockchain wallet where cryptographic currency is received for payment, etc. The processing server 102 can identify a transaction history for the transaction account and determine the transaction authenticity score based thereon, where a transaction history indicative of fraudulent activity can result in a lower transaction authenticity score. Factors that can be indicative of fraudulent activity can include a limited transaction history, an unusually high (e.g., compared to other transaction accounts) transaction history, a high frequency of transactions with a limited number of other transaction accounts (e.g., indicative of one or more nefarious actors performing a large number of transfers to appear genuine), past transactions that have been found to involve fraud, etc. The transaction data can be identified by the processing server 102 directly or via one or more payment processors 114. A payment processor 114 can be an entity that is configured to process payment transactions involving the transaction account or otherwise collect and/or analyze transaction histories of the transaction account, where such data can be made available to the processing server 102 for use in performing the functions discussed herein. In such embodiments, the processing server 102 can also utilize the transaction authenticity score when calculating the confidence score for the NFT. The transaction authenticity score can be weighted similar to the other authenticity scores.

By taking into account authenticity scores for the marketplace system 112 and creator device 108 in addition to the authenticity of the NFT itself, the methods and systems discussed herein can provide a confidence score to a requesting device 110 regarding confidence as to the transaction itself in addition to the NFT. For example, a nefarious actor that intends to engage in fraudulent activity can offer a genuine, original NFT for sale. A confidence score based solely on the likelihood that the NFT is genuine for such an example would be very high. However, in the methods and systems discussed herein, the confidence score would be significantly lower when taking into account the seller's fraudulent activity, which can influence the user of the requesting device 110 to pass on the purchase. Thus, the methods and systems discussed herein can provide confidence to purchasers well beyond an existing system that can protect from all known scams regarding NFTs, such as phishing using fake marketplaces, the sale of plagiarized NFTs, the exploiting of wallet or marketplace vulnerabilities, and the use of additional transactions to overinflate the price of an NFT, providing for a significant technological improvement over existing systems.

### Processing Server

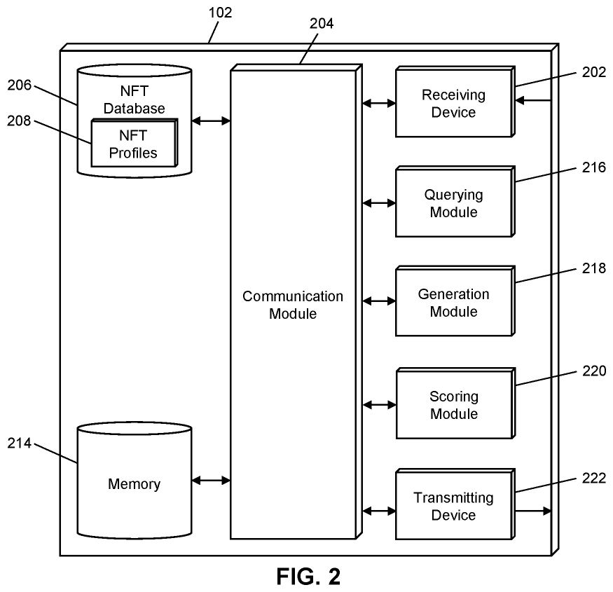

FIG. 2 illustrates an embodiment of the processing server 102 in the system 100 of FIG. 1. It will be apparent to persons having skill in the relevant art that the embodiment of the processing server 102 illustrated in FIG. 2 is provided as illustration only and cannot be exhaustive to all possible configurations of the processing server 102 suitable for performing the functions as discussed herein. For example, the computer system 500 illustrated in FIG. 5 and discussed in more detail below can be a suitable configuration of the processing server 102. In some cases, other components of the system 100, such as the blockchain nodes 106, creator device 108, requesting device 110, and marketplace system 112 can include the components illustrated in FIG. 2 and discussed below.

The processing server 102 can include a receiving device 202. The receiving device 202 can be configured to receive data over one or more networks via one or more network protocols. In some instances, the receiving device 202 can be configured to receive data from blockchain nodes 106, creator devices 108, requesting devices 110, marketplace systems 112, payment processors 114, marketplace data providers 116, and other systems and entities via one or more communication methods, such as radio frequency, local area networks, wireless area networks, cellular communication networks, Bluetooth, the Internet, etc. In some embodiments, the receiving device 202 can be comprised of multiple devices, such as different receiving devices for receiving data over different networks, such as a first receiving device for receiving data over a local area network and a second receiving device for receiving data via the Internet. The receiving device 202 can receive electronically transmitted data signals, where data can be superimposed or otherwise encoded on the data signal and decoded, parsed, read, or otherwise obtained via receipt of the data signal by the receiving device 202. In some instances, the receiving device 202 can include a parsing module for parsing the received data signal to obtain the data superimposed thereon. For example, the receiving device 202 can include a parser program configured to receive and transform the received data signal into usable input for the functions performed by the processing device to carry out the methods and systems described herein.

The receiving device 202 can be configured to receive data signals electronically transmitted by blockchain nodes 106 and creator devices 108 that can be superimposed or otherwise encoded with blockchain data, which can include blockchain data entries, transaction histories, NFT data, blockchain wallet data, etc. The receiving device 202 can also be configured to receive data signals electronically transmitted by requesting devices 110, which can be superimposed or otherwise encoded with scoring requests, which can include NFTs, identification data, transaction account data, marketplace identifiers, etc. The receiving device 202 can also be configured to receive data signals electronically transmitted by marketplace systems 112, payment processors 114, marketplace data providers 116, and other entities that can be superimposed or otherwise encoded with data for use in determining authenticity scores as discussed herein, such as transaction histories, visual features, suspicious wallet data, fraud determinations, marketplace metrics, etc.

The processing server 102 can also include a communication module 204. The communication module 204 can be configured to transmit data between modules, engines, databases, memories, and other components of the processing server 102 for use in performing the functions discussed herein. The communication module 204 can be comprised of one or more communication types and utilize various communication methods for communications within a computing device. For example, the communication module 204 can be comprised of a bus, contact pin connectors, wires, etc. In some embodiments, the communication module 204 can also be configured to communicate between internal components of the processing server 102 and external components of the processing server 102, such as externally connected databases, display devices, input devices, etc. The processing server 102 can also include a processing device. The processing device can be configured to perform the functions of the processing server 102 discussed herein as will be apparent to persons having skill in the relevant art. In some embodiments, the processing device can include and/or be comprised of a plurality of engines and/or modules specially configured to perform one or more functions of the processing device, such as a querying module 216, generation module 218, scoring module 220, etc. As used herein, the term “module” can be software or hardware particularly programmed to receive an input, perform one or more processes using the input, and provides an output. The input, output, and processes performed by various modules will be apparent to one skilled in the art based upon the present disclosure.

The processing server 102 can also include an NFT database 206. The NFT database 206 can be configured to store one or more NFT profiles 208 using a suitable data storage format and schema. The NFT database 206 can be a relational database that utilizes structured query language for the storage, identification, modifying, updating, accessing, etc. of structured data sets stored therein. Each NFT profile 208 can be a structured data set configured to store data related to an NFT. An NFT profile 208 can include, for example, identification data associated with the NFT, information identifying blockchain data entries storing data regarding NFT registration and transfers, visual features, blockchain wallet data associated with the creator device 108 and/or any other owners of the NFT, etc.

The processing server 102 can also include a memory 214. The memory 214 can be configured to store data for use by the processing server 102 in performing the functions discussed herein, such as public and private keys, symmetric keys, etc. The memory 214 can be configured to store data using suitable data formatting methods and schema and can be any suitable type of memory, such as read-only memory, random access memory, etc. The memory 214 can include, for example, encryption keys and algorithms, communication protocols and standards, data formatting standards and protocols, program code for modules and application programs of the processing device, and other data that can be suitable for use by the processing server 102 in the performance of the functions disclosed herein as will be apparent to persons having skill in the relevant art. In some embodiments, the memory 214 can be comprised of or can otherwise include a relational database that utilizes structured query language for the storage, identification, modifying, updating, accessing, etc. of structured data sets stored therein. The memory 214 can be configured to store, for example, cryptographic keys, cryptographic key pairs, cryptographic algorithms, encryption algorithms, communication information, data formatting rules, network identifiers, marketplace identifiers, transaction histories, visual features, suspicious blockchain wallet data, trusted NFT data, trusted marketplace data, suspicious marketplace data, etc.

The processing server 102 can include a querying module 216. The querying module 216 can be configured to execute queries on databases to identify information. The querying module 216 can receive one or more data values or query strings and can execute a query string based thereon on an indicated database, such as the NFT database 208 of the processing server 102 to identify information stored therein. The querying module 216 can then output the identified information to an appropriate engine or module of the processing server 102 as necessary. The querying module 216 can, for example, execute a query on the NFT database 208 to identify an NFT profile 210 associated with an NFT for which a scoring request is received, such as for use in identifying visual features and/or registration data for the NFT for use in performing the functions discussed herein.

The processing server 102 can also include a generation module 218. The generation module 218 can be configured to generate data for use by the processing server 102 in performing the functions discussed herein. The generation module 218 can receive instructions as input, can generate data based on the instructions, and can output the generated data to one or more modules of the processing server 102. For example, the generation module 218 can be configured to generate data messages, notification messages, response messages, marketplace authenticity scores, visual authenticity scores, wallet authenticity scores, transaction authenticity scores, etc.

The processing server 102 can also include a scoring module 220. The scoring module 220 can be configured to calculate scores for the processing server 102 as part of the functions discussed herein. The scoring module 220 can receive instructions as input, which can also include data to be used in calculating a score, can calculate a score as requested, and can output a result of the scoring to another module or engine of the processing server 102. The scoring module 220 can, for example, be configured to calculate a confidence score using a plurality of authenticity scores, which can be weighted, and where such weighting can be static or dynamic.

The processing server 102 can also include a transmitting device 222. The transmitting device 222 can be configured to transmit data over one or more networks via one or more network protocols. In some instances, the transmitting device 222 can be configured to transmit data to blockchain nodes 106, creator devices 108, requesting devices 110, marketplace systems 112, payment processors 114, marketplace data providers 116, and other entities via one or more communication methods, local area networks, wireless area networks, cellular communication, Bluetooth, radio frequency, the Internet, etc. In some embodiments, the transmitting device 222 can be comprised of multiple devices, such as different transmitting devices for transmitting data over different networks, such as a first transmitting device for transmitting data over a local area network and a second transmitting device for transmitting data via the Internet. The transmitting device 222 can electronically transmit data signals that have data superimposed that can be parsed by a receiving computing device. In some instances, the transmitting device 222 can include one or more modules for superimposing, encoding, or otherwise formatting data into data signals suitable for transmission.

The transmitting device 222 can be configured to electronically transmit data signals to blockchain nodes 106 and creator devices 108 that are superimposed or otherwise encoded with blockchain data requests, such as to request NFT data, blockchain data values, blockchain wallet transaction histories, blockchain wallet data, etc. The transmitting device 222 can also be configured to electronically transmit data signals to requesting devices 110, which can be superimposed or otherwise encoded with response messages, which can include a confidence score and, in some cases, authenticity scores, which can further include weighting information. The transmitting device 222 can also be configured to electronically transmit data signals to marketplace systems 112, payment processor 114, marketplace data providers 116, and other systems that can be superimposed or otherwise encoded with data requests, such as to request transaction histories, visual features, suspicious wallet data, fraud determinations, marketplace metrics, etc.

### Process for Authenticity Scoring a Non-Fungible Token

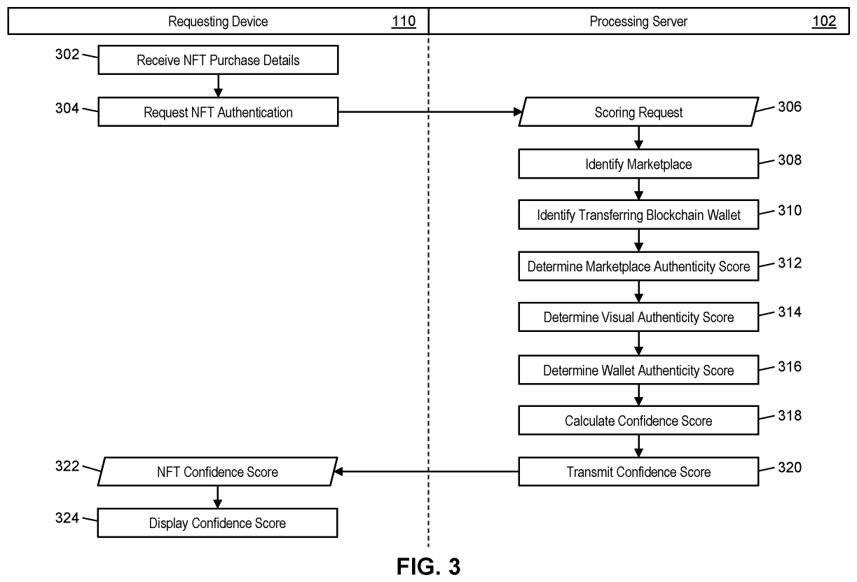

FIG. 3 a process for scoring a non-fungible token (NFT) and potential transfer thereof for authenticity in the system 100 of FIG. 1.

In step 302, the requesting device 110 can receive details regarding the potential purchase of an NFT via the marketplace system 112. The requesting device 110 can receive the details via any suitable method, such as transmission from the marketplace system 112, via an interface with the marketplace system 112 (e.g., webpage, application program, etc.), transmission from the creator device 108, etc. The details can include at least an identifier associated with the NFT, and can further include a marketplace identifier associated with the marketplace system 112 and a public key or other identifier of the creator device 108. In step 304, the requesting device 110 can electronically transmit a scoring request to request a confidence score for the NFT to the processing server 102 using a suitable communication network and method. In step 306, the receiving device 202 of the processing server 102 can receive the scoring request from the requesting device 110.

In step 308, the processing server 102 can identify the marketplace system 112 on which the NFT is available for purchase, such as by using the identifier included in the scoring request or identifying the marketplace system 112 using an NFT profile 210 in the NFT database 206 in the processing server 102 using the NFT identifier included in the scoring request. In step 310, the processing server 102 can also identify the blockchain wallet that has ownership of the NFT on the blockchain that has made the NFT available for sale via the marketplace system 112. The blockchain wallet can be identified via the identifier included in the scoring request, in the NFT profile 210, or by requesting such data from a blockchain node 106, marketplace system 112, or other suitable entity.

In step 312, the generation module 218 of the processing server 102 can generate a marketplace authenticity score for the NFT based on at least one or more marketplace metrics of the marketplace system 112 identified in step 308, and can be further based on one or more visual features of the marketplace system 112, which can be compared to visual features of known or trusted NFT marketplaces. In step 314, the generation module 218 of the processing server 102 can also generate a visual authenticity score for the NFT, which can be based on a comparison of one or more visual features of the NFT with visual features for a plurality of NFTs, which can be trusted NFTs that were previously determined to be genuine. In some cases, the visual authenticity score can be further based on a registration time and/or date of the NFT that is being scored compared to the registration time and/or date of any of the plurality of NFTs that have the same or similar visual features. In step 316, the generation module 218 of the processing server 102 can generate a wallet authenticity score for the NFT, which can be based on at least the transaction history of the blockchain wallet identified in step 310, and can be further based on whether or not the identified blockchain wallet can be found on any list of suspicious blockchain wallets.

In step 318, the scoring module 220 of the processing server 102 can calculate a confidence score for the NFT based on at least the marketplace authenticity score, the visual authenticity score, and the wallet authenticity score. In some cases, the authenticity scores can be dynamically weighted by the scoring module 220 to calculate the confidence score. In step 320, the transmitting device 222 of the processing server 102 can electronically transmit the confidence score to the requesting device 110 in response to the scoring request using a suitable communication network and method. In some cases, the processing server 102 can also transmit the authenticity scores to the requesting device 110. In step 322, the requesting device 110 can receive the confidence score for the NFT from the processing server 102. In step 324, the requesting device 110 can display the received confidence score for use by a user thereof in determining whether or not to proceed with the purchase of the NFT.

### Exemplary Method for Authenticity Scoring a Non-Fungible Token

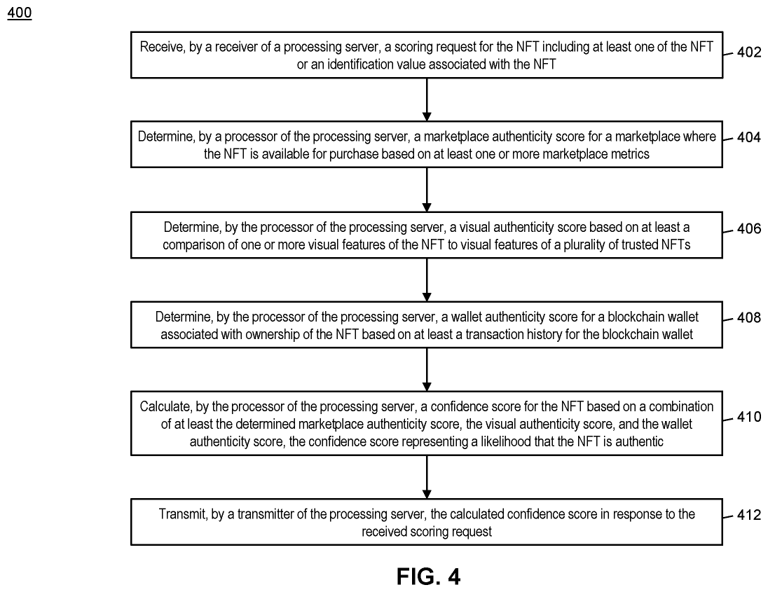

FIG. 4 illustrates a method 400 for the scoring of the authenticity of a non-fungible token (NFT) using multiple, disparate data sets.

In step 402, a scoring request for an NFT can be received by a receiver (e.g., receiving device 202) of a processing server (e.g., the processing server 102), the scoring request including at least one of the NFT or an identification value associated with the NFT. In step 404, a marketplace authenticity score can be determined by a processor (e.g., generation module 218) of the processing server for a marketplace (e.g., marketplace system 112) where the NFT is available for purchase based on at least one or more marketplace metrics. In step 406, a visual authenticity score can be determined by the processor (e.g., generation module 218) of the processing server based on at least a comparison of one or more visual features of the NFT to visual features of a plurality of trusted NFTs.

In step 408, a wallet authenticity score can be determined by the processor (e.g., generation module 218) of the processing server for a blockchain wallet associated with ownership of the NFT based on at least a transaction history for the blockchain wallet. In step 410, a confidence score can be calculated for the NFT by the processor (e.g., scoring module 220) based on a combination of at least the determined marketplace authenticity score, the visual authenticity score, and the wallet authenticity score, the confidence score representing a likelihood that the NFT is authentic. In step 412, the calculated confidence score can be transmitted by a transmitter (e.g., transmitting device 222) of the processing server in response to the receiving scoring request.

In one embodiment, the one or more marketplace metrics can include at least one of: a popularity rank, domain registration data, network activity, and social media traffic for a webpage or application program associated with the marketplace. In some embodiments, the marketplace authenticity score can be determined using an Extreme Gradient Boosting model. In one embodiment, the marketplace authenticity score can be further based on a comparison of one or more visual features of the marketplace to visual features of a plurality of trusted marketplaces. In a further embodiment, the comparison of the one or more visual features of the marketplace to visual features of a plurality of trusted marketplaces can use one of: a Siamese model, a Deep Learning model, and Feature Maps.

In some embodiments, the marketplace authenticity score can be further based on whether or not the marketplace is identified in a database of trusted marketplaces. In one embodiment, the comparison of the one or more visual features of the NFT to visual features of a plurality of trusted NFTs can use one of: a Siamese model, a Deep Learning model, and Feature Maps. In some embodiments, the method 400 can further include determining, by the processor (e.g., generation module 218) of the processing server, a transaction authenticity score based on at least a transaction history for a transaction account associated with the NFT, wherein the confidence score can be further based on the transaction authenticity score. In one embodiment, the wallet authenticity score can be further based on whether or not the blockchain wallet is identified in a database of suspicious blockchain wallets.

### Computer System Architecture

FIG. 5 illustrates a computer system 500 in which embodiments of the present disclosure, or portions thereof, can be implemented as computer-readable code. For example, the processing server 102, blockchain nodes 106, creator device 108, requesting device 110, and marketplace system 112 can be implemented in the computer system 500 using hardware, non-transitory computer readable media having instructions stored thereon, or a combination thereof and can be implemented in one or more computer systems or other processing systems. Hardware can embody modules and components used to implement the methods of FIGS. 3 and 4.

If programmable logic is used, such logic can execute on a commercially available processing platform configured by executable software code to become a specific purpose computer or a special purpose device (e.g., programmable logic array, application-specific integrated circuit, etc.). A person having ordinary skill in the art can appreciate that embodiments of the disclosed subject matter can be practiced with various computer system configurations, including multi-core multiprocessor systems, minicomputers, mainframe computers, computers linked or clustered with distributed functions, as well as pervasive or miniature computers that can be embedded into virtually any device. For instance, at least one processor device and a memory can be used to implement the above described embodiments.

A processor unit or device as discussed herein can be a single processor, a plurality of processors, or combinations thereof. Processor devices can have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations can be described as a sequential process, some of the operations can in fact be performed in parallel, concurrently, and/or in a distributed environment, and with program code stored locally or remotely for access by single or multi-processor machines. In addition, in some embodiments the order of operations can be rearranged without departing from the spirit of the disclosed subject matter.

Processor device 504 can be a special purpose or a general purpose processor device specifically configured to perform the functions discussed herein. The processor device 504 can be connected to a communications infrastructure 506, such as a bus, message queue, network, multi-core message-passing scheme, etc. The network can be any network suitable for performing the functions as disclosed herein and can include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 can also include a main memory 508 (e.g., random access memory, read-only memory, etc.), and can also include a secondary memory 510. The secondary memory 510 can include the hard disk drive 512 and a removable storage drive 514, such as a floppy disk drive, a magnetic tape drive, an optical disk drive, a flash memory, etc.

The removable storage drive 514 can read from and/or write to the removable storage unit 518 in a well-known manner. The removable storage unit 518 can include a removable storage media that can be read by and written to by the removable storage drive 514. For example, if the removable storage drive 514 is a floppy disk drive or universal serial bus port, the removable storage unit 518 can be a floppy disk or portable flash drive, respectively. In one embodiment, the removable storage unit 518 can be non-transitory computer readable recording media.

In some embodiments, the secondary memory 510 can include alternative means for allowing computer programs or other instructions to be loaded into the computer system 500, for example, the removable storage unit 522 and an interface 520. Examples of such means can include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) can be stored on any type of suitable computer readable media, such as optical storage (e.g., a compact disc, digital versatile disc, Blu-ray disc, etc.) or magnetic tape storage (e.g., a hard disk drive). The data can be configured in any type of suitable database configuration, such as a relational database, a structured query language (SQL) database, a distributed database, an object database, etc. Suitable configurations and storage types will be apparent to persons having skill in the relevant art.

The computer system 500 can also include a communications interface 524. The communications interface 524 can be configured to allow software and data to be transferred between the computer system 500 and external devices. Exemplary communications interfaces 524 can include a modem, a network interface (e.g., an Ethernet card), a communications port, a PCMCIA slot and card, etc. Software and data transferred via the communications interface 524 can be in the form of signals, which can be electronic, electromagnetic, optical, or other signals as will be apparent to persons having skill in the relevant art. The signals can travel via a communications path 526, which can be configured to carry the signals and can be implemented using wire, cable, fiber optics, a phone line, a cellular phone link, a radio frequency link, etc.

The computer system 500 can further include a display interface 502. The display interface 502 can be configured to allow data to be transferred between the computer system 500 and external display 530. Exemplary display interfaces 502 can include high-definition multimedia interface (HDMI), digital visual interface (DVI), video graphics array (VGA), etc. The display 530 can be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium can refer to memories, such as the main memory 508 and secondary memory 510, which can be memory semiconductors (e.g., DRAMs, etc.). These computer program products can be means for providing software to the computer system 500. Computer programs (e.g., computer control logic) can be stored in the main memory 508 and/or the secondary memory 510. Computer programs can also be received via the communications interface 524. Such computer programs, when executed, can enable computer system 500 to implement the present methods as discussed herein. In particular, the computer programs, when executed, can enable processor device 504 to implement the methods illustrated by FIGS. 3 and 4, as discussed herein. Accordingly, such computer programs can represent controllers of the computer system 500. Where the present disclosure is implemented using software, the software can be stored in a computer program product and loaded into the computer system 500 using the removable storage drive 514, interface 520, and hard disk drive 512, or communications interface 524.

The processor device 504 can comprise one or more modules or engines configured to perform the functions of the computer system 500. Each of the modules or engines can be implemented using hardware and, in some instances, can also utilize software, such as corresponding to program code and/or programs stored in the main memory 508 or secondary memory 510. In such instances, program code can be compiled by the processor device 504 (e.g., by a compiling module or engine) prior to execution by the hardware of the computer system 500. For example, the program code can be source code written in a programming language that is translated into a lower-level language, such as assembly language or machine code, for execution by the processor device 504 and/or any additional hardware components of the computer system 500. The process of compiling can include the use of lexical analysis, preprocessing, parsing, semantic analysis, syntax-directed translation, code generation, code optimization, and any other techniques that can be suitable for translation of program code into a lower-level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for scoring authenticity of a non-fungible token using multiple, disparate data sets. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or can be acquired from practicing of the disclosure, without departing from the breadth or scope.

What is claimed is:

1. A method for scoring authenticity of a non-fungible token (NFT) using multiple, disparate data sets, comprising:
receiving, by a receiver of a processing server, a scoring request for the NFT including at least one of the NFT or an identification value associated with the NFT;
determining, by a processor of the processing server, a marketplace authenticity score for a marketplace where the NFT is available for purchase based on at least one or more marketplace metrics;
determining, by the processor of the processing server, a visual authenticity score based on at least a comparison of one or more visual features of the NFT to visual features of a plurality of trusted NFTs;
determining, by the processor of the processing server, a wallet authenticity score for a blockchain wallet associated with ownership of the NFT based on at least a transaction history for the blockchain wallet;
calculating, by the processor of the processing server, a confidence score for the NFT based on a combination of at least the determined marketplace authenticity score, the visual authenticity score, and the wallet authenticity score, the confidence score representing a likelihood that the NFT is authentic; and
transmitting, by a transmitter of the processing server, the calculated confidence score in response to the received scoring request.

2. The method of claim 1, wherein the one or more marketplace metrics includes at least one of: a popularity rank, domain registration data, network activity, and social media traffic for a webpage or application program associated with the marketplace.

3. The method of claim 1, wherein the marketplace authenticity score is determined using an Extreme Gradient Boosting model.

4. The method of claim 1, wherein the marketplace authenticity score is further based on a comparison of one or more visual features of the marketplace to visual features of a plurality of trusted marketplaces.

5. The method of claim 4, wherein the comparison of the one or more visual features of the marketplace to visual features of a plurality of trusted marketplaces uses one of: a Siamese model, a Deep Learning model, and Feature Maps.

6. The method of claim 1, wherein the marketplace authenticity score is further based on whether or not the marketplace is identified in a database of trusted marketplaces.

7. The method of claim 1, wherein the comparison of the one or more visual features of the NFT to visual features of a plurality of trusted NFTs uses one of: a Siamese model, a Deep Learning model, and Feature Maps.

8. The method of claim 1, further comprising:
determining, by the processor of the processing server, a transaction authenticity score based on at least a transaction history for a transaction account associated with the NFT, wherein
the confidence score is further based on the transaction authenticity score.

9. The method of claim 1, wherein the wallet authenticity score is further based on whether or not the blockchain wallet is identified in a database of suspicious blockchain wallets.

10. A system for scoring authenticity of a non-fungible token (NFT) using multiple, disparate data sets, comprising:
a blockchain wallet associated with ownership of the NFT;
a marketplace; and
a processing server, the processing server including
a receiver receiving a scoring request for the NFT including at least one of the NFT or an identification value associated with the NFT;
a processor
determining (i) a marketplace authenticity score for the marketplace where the NFT is available for purchase based on at least one or more marketplace metrics, (ii) a visual authenticity score based on at least a comparison of one or more visual features of the NFT to visual features of a plurality of trusted NFTs, and (iii) a wallet authenticity score for the blockchain wallet based on at least a transaction history for the blockchain wallet, and
calculating a confidence score for the NFT based on a combination of at least the determined marketplace authenticity score, the visual authenticity score, and the wallet authenticity score, the confidence score representing a likelihood that the NFT is authentic; and
a transmitter transmitting the calculated confidence score in response to the received scoring request.

11. The system of claim 10, wherein the one or more marketplace metrics includes at least one of: a popularity rank, domain registration data, network activity, and social media traffic for a webpage or application program associated with the marketplace.

12. The system of claim 10, wherein the marketplace authenticity score is determined using an Extreme Gradient Boosting model.

13. The system of claim 10, wherein the marketplace authenticity score is further based on a comparison of one or more visual features of the marketplace to visual features of a plurality of trusted marketplaces.

14. The system of claim 13, wherein the comparison of the one or more visual features of the marketplace to visual features of a plurality of trusted marketplaces uses one of: a Siamese model, a Deep Learning model, and Feature Maps.

15. The system of claim 10, wherein the marketplace authenticity score is further based on whether or not the marketplace is identified in a database of trusted marketplaces.

16. The system of claim 10, wherein the comparison of the one or more visual features of the NFT to visual features of a plurality of trusted NFTs uses one of: a Siamese model, a Deep Learning model, and Feature Maps.

17. The system of claim 10, wherein
the processor of the processing server determines a transaction authenticity score based on at least a transaction history for a transaction account associated with the NFT, and
the confidence score is further based on the transaction authenticity score.

18. The system of claim 10, wherein the wallet authenticity score is further based on whether or not the blockchain wallet is identified in a database of suspicious blockchain wallets.
